(19) United States
(12) Patent Application Publication
(10) Pub. No.: US 2003/0090568 A1
(43) Pub. Date: May 15, 2003

(54) Digital imaging rear view mirror system

(76) Inventor: Thomas Michael Pico, Honolulu, HI (US)

Correspondence Address: Thomas M. Pico, Jr., P.O. Box 835, Honolulu, HI, 96808-0835, US

(21) Appl. No.: 09/839,092

(22) Filed: Apr. 23, 2001

(51) Int. Cl. H04N 7/18

(52) U.S. Cl. 348/148; 180/271; 345/30

(57) ABSTRACT

The Digital Imaging Rear View Mirror System Utilizes a digital camera located low in the rear of a motor vehicle and cameras located on the sides of a vehicle all connected to a small flat panel display (e.g., LCD) located in front of the driver. The images from the cameras are to be digitally integrated so as to provide a seamless rear and side view. The Digital Imaging Rear View Mirror System incorporates a recorder that records 15 to 20 minute continuous segments while the vehicle is in operation and stops recording a few minutes after a collision. The System also incorporates a sensor that displays in real time on the LCD and on the recording the distance of objects and vehicles behind the vehicle equipped with a Digital Imaging Rear View Mirror System, the speed of the vehicle equipped with a Digital Imaging Rear View Mirror System and the time.

### CROSS-REFERENCE TO RELATED APPLICATIONS

None

### STATEMENT REGARDING FEDERALLY SPONSORED RESEARCH OF DEVELOPMENT

Not federally sponsored.

### REFERENCE TO MICROFICHE APPENDIX

Not applicable.

### BACKGROUND OF THE INVENTION

1. Field of Invention

Motor Vehicle (Class 180); Safety devices involving a feature limited to use on motor vehicles.

2. Description of Prior Art

Glass rear/side view mirrors presently utilized on motor vehicles have blind spots that are significant causes of accidents and do not provide to accident investigators any information regarding rear-end accident causation.

### BRIEF SUMMARY OF THE INVENTION

Utilizes a digital camera located low in the rear of a motor vehicle, (e.g. the trunk area of cars and SUV's, the bumper area of large trucks and vans) and cameras located on the sides of a vehicle all connected to a small flat panel display (e.g., LCD) located in front of the driver. The images from the cameras are to be digitally integrated so as to provide a seamless rear and side view. This would eliminate blind spots, especially the blind spot directly behind a vehicle that has resulted in injury and death to small children who cannot be seen by the driver with the present rear view system. This would also eliminate any hard to see areas along the sides of the vehicle caused by improper side view mirror positioning.

The Digital Imaging Rear View Mirror System is not merely a visual device but most significantly incorporates a recorder that records 15 to 20 minute continuous segments while the vehicle is in operation and stops recording a few minutes after a collision. The system also incorporates a sensor that displays in real time on the LCD and on the recording the distance of objects and vehicles behind the vehicle equipped with a Digital Imaging Rear View Mirror System, the speed of the vehicle equipped with a Digital Imaging Rear View Mirror System and the time. These information displays could be turned off for the LCD panel so as not to distract a driver who does not need the information but would remain on the 15-20 minute recording so that accident investigators could review the recording with its saved information and obtain accurate and irrefutable evidence of the sequence and timing of a rear-end collision, the visibility at the time of the collision and the relative speeds of the vehicles involved in a rear-end collision.

### BRIEF DESCRIPTION OF THE SEVERAL VIEWS OF THE DRAWING

Not applicable no drawings submitted.

### DETAILED DESCRIPTION OF THE INVENTION/DESCRIPTION OF THE PREFERRED EMBODIMENT

Utilizes a digital camera, preferably with wide-angle lens, located low in the rear of a motor vehicle, (e.g. the trunk area of cars and SUV's, the bumper area of large trucks and vans) and cameras located on each side of a vehicle all connected to a small flat panel display (e.g., LCD) located in front of the driver. The images from the cameras are to be digitally integrated so as to provide a seamless rear and side view. The display would ideally be rectangular approximately 3-4 inches high and 5-6 inches long. It could be placed in the dashboard, in the center of the steering wheel, overhead on a sun visor, on the windshield where rear view mirrors are presently located or in any other convenient location.

The Digital Imaging Rear View Mirror System is not merely a visual device but most significantly incorporates a recorder that records 15 to 20 minute continuous segments of visual and other pertinent information while the vehicle is in operation and stops recording a few minutes after a collision. The recorder could be activated by turning the ignition key on and stopped after a 3 to 5 minute delay by any number of events such as an inertia sensor, air-bag deployment, and, of course, turning the ignition off. The system incorporates a sensor that displays in real time on the LCD and on the recording the distance of objects and vehicles directly behind the vehicle equipped with a Digital Imaging Rear View Mirror System. This sensor could utilize infrared or laser or similar technology to target precisely the object or vehicle closest to the vehicle equipped with a Digital Imaging Rear View Mirror System. A “red-dot” targeting image could be utilized so that anyone viewing the recording would know exactly what object/vehicle the distance sensor targeted. The Digital Imaging Rear View Mirror System would also display the speed of the vehicle equipped with a Digital Imaging Rear View Mirror System and the time. These information displays could be turned off for the LCD panel so as not to distract a driver who does not need the information but would remain on the 15-20 minute recording. The recording device would ideally be isolated from the cameras so as to avoid damage in even a severe collision and be in a collision-proof and tamper-proof container analogous to the “black box” used on aircraft.

1. I claim as my invention the use of digital cameras for rear and side view imaging for motor vehicles.

2. I claim as my invention the use of a flat panel display of the views along the sides and behind a motor vehicle.

3. I claim as my invention the use of a flat panel display with an integrated seamless image of the views along side and behind a motor vehicle.

4. I claim as my invention the use of a recording device to capture the camera views along the sides and behind a motor vehicle.

5. I claim as my invention the use of a distance sensor incorporated with the camera views and recording device capturing the views along the sides and behind a motor vehicle.

6. I claim as my invention the use of a speed sensor incorporated with the camera views and recording device capturing the views along the sides and behind a motor vehicle.

7. I claim as my invention the use of a timer incorporated with the camera views and recording device capturing the views along the sides and behind a motor vehicle.
